(19) United States
(12) Patent Application Publication
(10) Pub. No.: US 2016/0120091 A1
(43) Pub. Date: May 5, 2016

(54) System for removing implanted objects from the ground

(71) Applicants: Ian R. Lawson, Danbury, CT (US); Stephen P. Casey, Danbury, CT (US)

(72) Inventors: Ian R. Lawson, Danbury, CT (US); Stephen P. Casey, Danbury, CT (US)

(21) Appl. No.: 14/932,939

(22) Filed: Nov. 4, 2015

Related U.S. Application Data
(60) Provisional application No. 62/123,033, filed on Nov. 5, 2014.

(51) Int. Cl. A01B 1/16; A01G 23/06

(52) U.S. Cl. CPC A01B 1/16; A01G 23/062

(57) ABSTRACT

The present invention presents a system for removing implanted objects from the ground comprising an elongated tubing and a support structure. The elongated tubing having a top surface, a bottom surface, a first end and a second end, the first end having an eccentrically cut point. The top surface of the elongated tubing having a stop for coupling the support structure to the elongated tubing. The support structure comprising a fulcrum for providing a stable bearing surface for when downward force is applied to the second end of the elongated tubing and a hanger for connecting the fulcrum to the elongated tubing.

### CROSS REFERENCE TO RELATED APPLICATIONS

This application claims the benefit of U.S. Provisional Patent Application Ser. No. 62/123,033, filed Nov. 5, 2014.

### BACKGROUND

1. Field of the Invention

The present invention relates generally to gardening tools, and more specifically to a tool for removing implanted objects from the ground.

2. Description of Related Art

The removal of unwanted shrubs, bushes, roots, small trees and like objects is typically accomplished using pry-bars, picks, shovels and post-lifters. While effective, these tools are cumbersome and without a fulcrum or another similar support object their use can require a considerable amount of physical strength. Furthermore, a stone or log of the right size and shape to use as a fulcrum is often too far away and too heavy to carry around from job to job. Pry-bars and shovels tend to weigh between 12 pounds and 18 pounds and are rather heavy for smaller or elderly people. Post-lifters are typically used to lift posts, trees and fences out of the ground however, they are limited to vertical lifting and are unable to remove objects where removal must be accomplished by lifting from underneath the object. What is needed is a versatile, light-weight and portable tool for the removal of objects which are implanted in the ground.

### SUMMARY OF THE INVENTION

In view of the foregoing disadvantages in the known types of gardening tools, the present invention presents a superior gardening tool for the efficient removal of implanted objects from the ground. The present invention is light-weight and portable, and its use is less laborious than the known types of gardening tools currently used for removing implanted objects from the ground. The present invention comprises an elongated tubing with a point on one end of the tubing, the point to be inserted into the ground under the implanted object and a support structure where the support structure acts as a bearing surface for the elongated tubing when downward force is applied to the elongated tubing. These and other features of the present invention will become readily apparent upon further review of the following specification and drawings.

### BRIEF DESCRIPTION OF DRAWINGS

Embodiments of the present invention will be described by way of example only, and not limitation, with reference to the accompanying drawings in which:

FIG. 1 is a perspective view of a system for removing implanted objects from the ground according to the present invention;

FIG. 2 is a perspective view of a point of a system for removing implanted objects from the ground according to the present invention;

FIG. 3 is a perspective view of a plane on which a point is cut in a system for removing objects from the ground according to the present invention;

FIG. 4 is a cross-sectional view of a support structure according to the present invention.

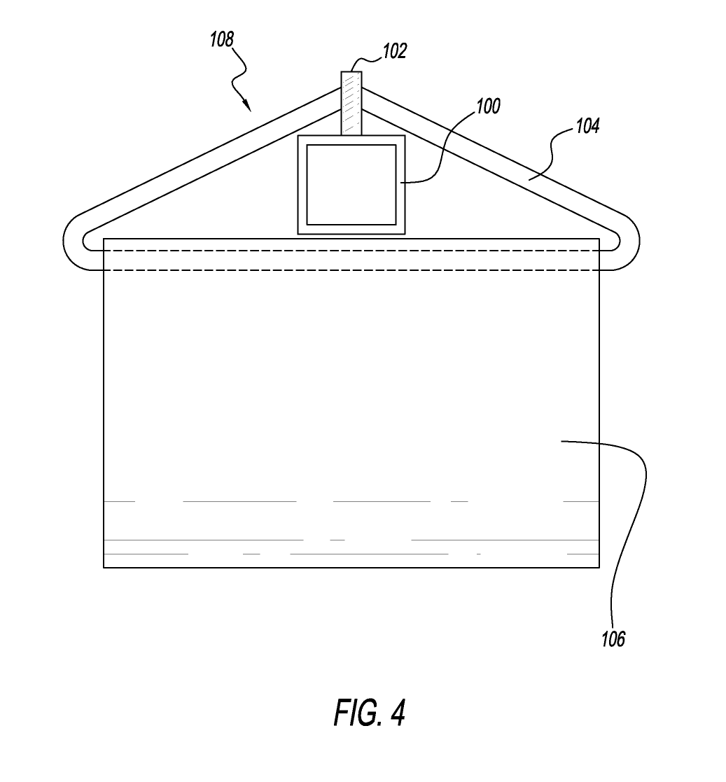

FIG. 5 is an environmental perspective view of a system for removing implanted objects from the ground according to the present invention; and

FIG. 6 is an environmental side view of a system for removing implanted objects from the ground according to the present invention.

### DETAILED DESCRIPTION OF THE INVENTION

The present invention presents a system for removing implanted objects from the ground comprising an elongated tubing and a support structure. The elongated tubing having a top surface, a bottom surface, a first end and a second end, the first end having an eccentrically cut point. The top surface of the elongated tubing having a stop for coupling the support structure to the elongated tubing. The support structure comprising a fulcrum for providing a stable bearing surface for when downward force is applied to the second end of the elongated tubing and a hanger for connecting the fulcrum to the elongated tubing.

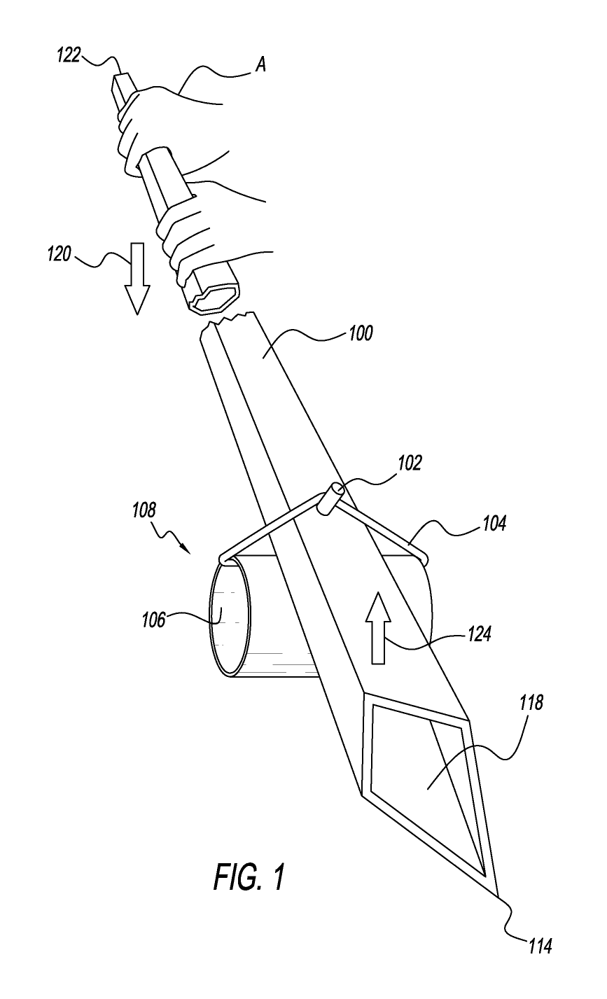

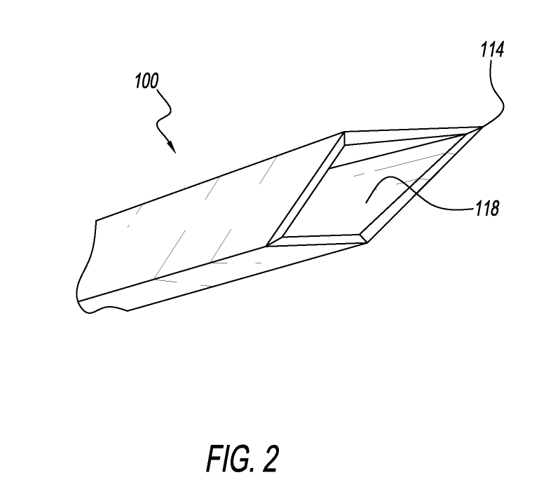

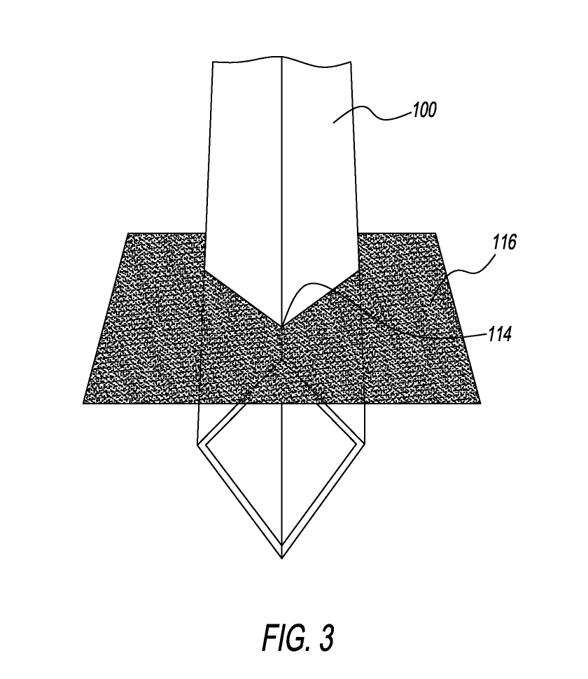

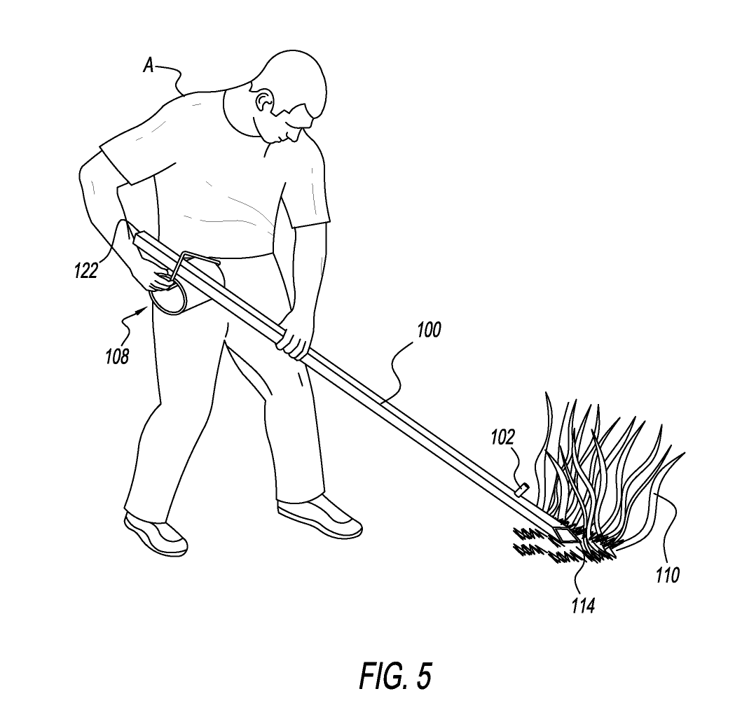

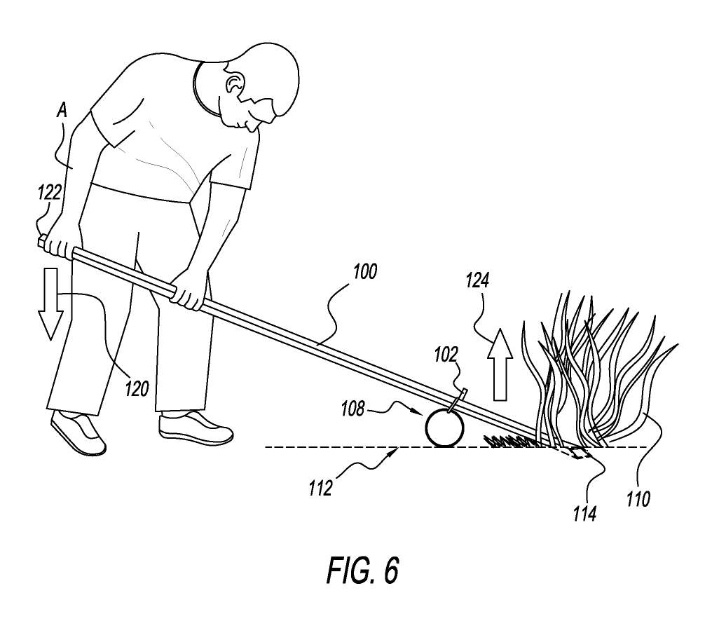

Referring now to the figures, where similar reference characters denote similar elements throughout the figures, FIGS. 1 and 5 show a perspective view, and FIG. 6 shows a side view, of a system for removing implanted objects from the ground according to the present invention. The system comprises an elongated tubing 100 with a top surface, a bottom surface, a first end, a second end 122 and a stop 102, where the first end has an eccentric point 114. The eccentric point 114 as shown in FIG. 2 is formed by cutting the elongated tubing 100 on the cut plane 116 as shown in FIG. 3 at an angle that varies from 45 degrees to 70 degrees, the point surface 118 either facing upward to the left, upward to the right, downward to the left or downward to the right. The support structure 108 providing a stable bearing surface for the elongated tubing 100 when downward force 120 is applied to the elongated tubing 100. The support structure 108 is coupled to the elongated tubing 100 at the stop 102. The stop 102 is located on the top surface of the elongated tubing 100 and may be a square, rectangle, cylinder, notch or hook attached to the elongated tubing via welding, screws or other attachment means generally known in the art. The stop ideally located in a position that is closer to the point 114 than to the second end 122 of the elongated tubing 100.

In an embodiment of the present invention the support structure 108 comprises a fulcrum 106 comprising a cross section of 4 inch to 8 inch diameter round steel tubing for providing a stable bearing surface for the elongated tubing 100 when downward force 120 is applied to the elongated tubing 100, and a hanger 104 attached to the fulcrum 106 for connecting the fulcrum 106 to the elongated tubing 100 by either resting on or coupling to the stop 102.

In one embodiment of the present invention the support structure 108 and the elongated tubing 100 are one permanently connected unit where the hanger 106 of the support structure 108 is coupled to the stop 102 of the elongated tubing 100 by welding or other coupling means generally known in the art. In another embodiment of the present invention as shown in FIG. 5 the support structure 108 and the elongated tubing 100 are separate elements of a kit for removing implanted objects from the ground 112.

In one embodiment of the present invention, as shown in FIGS. 5 and 6, the point 114 of the elongated tubing 100, with the point surface 118 facing upwards and to the right or upwards and to the left, is thrust into the ground 112 at an angle underneath the implanted object 110. The user A slides the hanger 104 of the support structure 108 from the second end 122 of the elongated tubing 100 towards the first end of the elongated tubing 100 until it reaches the stop 102. The support structure 108 couples with the elongated tubing 100 by coupling with the stop 102 as shown in FIG. 1. The user A applies downward force 120 near the second end 122 of the elongated tubing 100 forcing the point 114 upwards 124 and as a result lifting the implanted object 110 out of the ground 112. The mechanical advantage can be varied by shifting the fulcrum 106 and the position of user A's hands on the elongated tubing 100.

In a preferred embodiment of the present invention the elongated tubing 100 is a 6 inch long square tubing with a width of 1.25 inches, a wall thickness of 0.125 inches and a stop 102 which is 0.75 inches to 1 inch tall. The stop 102 is located approximately 12 inches from the point 114 and the point 114 is eccentrically cut at a 60 degree angle starting approximately 3 inches from the tip of the point 114. The point surface 118 facing upwards and to the right or upwards and to the left. The fulcrum 106 comprises a 6 inch section of round steel tubing with a 4 inch diameter and 0.125 inch wall thickness. The hanger 104 comprises 0.25 inches of round steel tubing which is formed around the fulcrum 106 to allow for a 0.375 inch clearance vertically and horizontally when the hanger 104 is slid down the elongated tubing 100 as shown in FIGS. 3 and 5. The hanger 104 and the fulcrum 106 are connected by forming the hanger 104 around the fulcrum 106 with a single weld to close the hanger 104. An ideal mechanical advantage of 5:1 is achieved by applying downward force 120 as close as possible to the second end 122 of the elongated tubing 100.

What is claimed is:

1. A tool for removing an implanted object from the ground, comprising:
(a) An elongated tubing having a first end, a second end, a top surface, a bottom surface and a stop, wherein the stop is attached to the top surface of the elongated tubing and the first end has a point; and
(b) A support structure coupled to the stop for providing a stable bearing surface for the tubing when downward force is applied.

2. The tool of claim 1, wherein the elongated tubing is from 5 feet to 7 feet long.

3. The tool of claim 1, wherein the elongated tubing is a square tubing.

4. The tool of claim 1, wherein the point is formed at an angle of 45 degrees to 70 degrees.

5. The system of claim 1, wherein the stop is located 12 inches away from the point.

6. The tool of claim 1, wherein the support structure couples to the elongated tubing by resting loosely on the stop.

7. The tool of claim 1, wherein the support structure couples to the elongated tubing by a secure connection to the stop.

8. The tool of claim 4, wherein the point begins 3 inches from the tip of the first end of the elongated tubing.

9. A system for removing an implanted object from the ground, comprising:
(a) A tool, comprising:
a. An elongated tubing having a first end, a second end, a top surface and a bottom surface, the first end having a point;
b. A stop attached to the top surface of the elongated tubing;
c. A support structure coupled to the stop for providing a stable bearing surface for the elongated tubing when downward force is applied to the elongated tubing, the support structure comprising:
i. A fulcrum;
ii. A hanger connected to the fulcrum for attaching the fulcrum to the elongated tubing by coupling to the stop; and
(b) An implanted objected, the implanted object being firmly set in the ground.

10. The system of claim 9, wherein the fulcrum is a cross section of round metal tubing.

11. The system of claim 9, wherein the elongated tubing is made of metal.

12. The system of claim 9, wherein the stop is located closer to the first end of the elongated tubing than the second end of the elongated tubing.

13. The method of removing an implanted object from the ground, comprising the steps of:
(a) Selecting the tool of claim 9;
(b) Thrusting the point of the elongated tubing at an angle into the ground under the implanted object;
(c) Sliding the hanger of the support structure from the second end of the elongated down the elongated tubing until it reaches the stop; and
(d) Pressing downwards on the second end of the elongated tubing to raise the implanted objected out of the ground.

14. The method of claim 13, wherein step (b) is repeated until the point of the elongated tubing is implanted securely underneath the implanted object.

15. The method of claim 13, wherein step (c) is completed before step (b).
